(19) United States
(12) Patent Application Publication
(10) Pub. No.: US 2012/0326865 A1
(43) Pub. Date: Dec. 27, 2012

(54) INTERFACE TESTING SYSTEM

(75) Inventors: ZHAO-JIE CAO, Shenzhen City (CN); WEI-DONG CONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/204,726

(22) Filed: Aug. 8, 2011

(30) Foreign Application Priority Data
Jun. 27, 2011 (CN) 201110174797.3

(51) Int. Cl. G08B 21/00; G06F 19/00

(52) U.S. Cl. 340/540; 702/109

(57) ABSTRACT

A testing system includes a computer system and an enhanced small form-factor pluggable (SFP+) transceiver. The computer system send a testing data to the SFP+ transceiver via an SFP+ interface to be tested. The SFP+ transceiver includes a loopback address and receives the testing data and returns the testing data to the computer system via the loopback address. The computer system compares the returned testing data and the testing data it sends to determine whether or not there is data loss occurring.

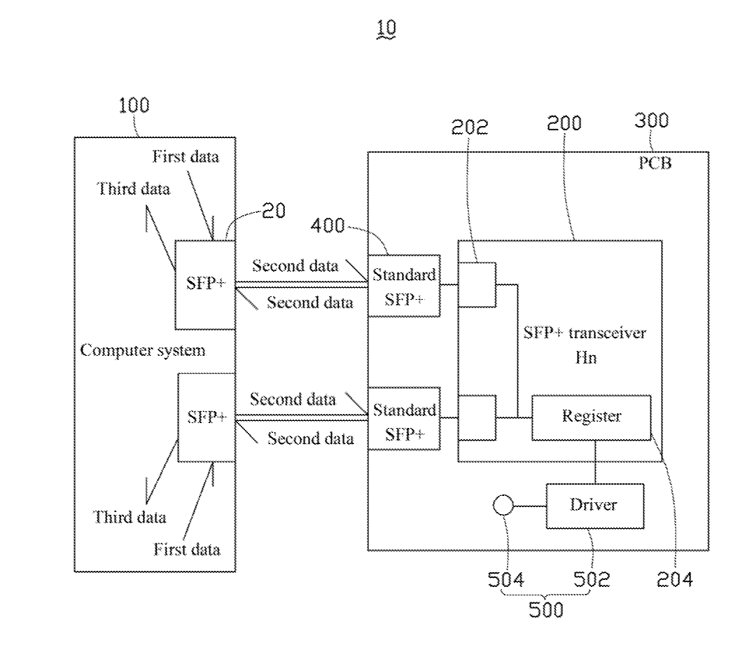

### BACKGROUND

1. Technical Field

The present disclosure relates to a testing system for testing an enhanced small form-factor pluggable (SFP+) interface.

2. Description of Related Art

At present, to test whether or not an SFP+ interface is installed and working properly, two computer systems are required. One is connected to a standard SFP+ interface (that is, a known working SFP+ interface), and the other is connected to an SFP+ interface to be tested. The computer systems send and receive data via the SFP+ interface, and analyze whether or not there is data loss in the sent and received data to determine whether or not the SFP+ interface passes. However, such testing is costly because of needing to use two high-cost computer systems.

Therefore, it is desirable to provide a testing system, which can overcome the limitations described.

### BRIEF DESCRIPTION OF THE DRAWING

Many aspects of the present disclosure can be better understood with reference to the following drawing. The components in the drawings are not necessarily drawn to scale, the emphasis instead being placed upon clearly illustrating the principles of the present disclosure.

The FIGURE is a functional block diagram of a testing system for testing two SFP+ interfaces.

### DETAILED DESCRIPTION

Embodiments of the present disclosure will now be described in detail with reference to the drawing.

Referring to the FIGURE, a testing system 10, according to an embodiment, includes a computer system 100 and an SFP+ transceiver 200. The computer system 100 is configured for connecting to two SFP+ interfaces 20 to be tested and sending first data to the SFP+ interfaces 20. Each of the SFP+ interfaces 20 forwards the first data as second data. The SFP+ transceiver 200 includes two loopback addresses 202. Each of the loopback addresses 202 is configured for connecting to a corresponding SFP+ interface 20. The SFP+ transceiver 200 is configured for receiving the second data via the loopback addresses 202 from the respective SFP+ interfaces 20 and returning third data, which corresponds to the second data, to the respective SFP+ interfaces 20 via the respective loopback addresses 202. Each of the SFP+ interfaces 20 forwards the third data as fourth data. The computer system 100 is configured for receiving the fourth data and analyzing whether or not the third data is identical to the first data to determine whether or not the SFP+ interfaces 20 pass.

Normally, the SFP+ transceiver 200 can work properly. That is, the third data is exactly identical to the second data. Therefore, if the fourth data is different from the first data, there is data loss occurring during forwarding the first data as the second data or during forwarding the third data as the fourth data by the SFP+ interface 20. In such cases, the corresponding SFP+ interface 20 fails to pass the testing. If the fourth data is identical to the first data, it can be determined that there is no data loss occurring during forwarding the first data as the second data or during forwarding the third data as the fourth data by the SFP+ interface 20. Thus, the SFP+ interface 20 passes the testing. Test results may be displayed on a screen of the computer system 100.

However, on rare occasions, the SFP+ transceiver 200 may malfunction, and data loss may occur during forwarding the second data as the third data by the SFP+ transceiver 200, that is, the third data is not identical to the third data.

To avoid mistakenly failing a working SFP+ interface 20, the SFP+ transceiver 200 can further include a register 204. The register 204 stores a flag bit. The SFP+ transceiver 200 can check whether or not the third data is identical to the second data, and change a value of the flag bit according to the check. For example, if the third data is different from the second data, the SFP+ transceiver 200 changes the value of the flag bit from a binary digit “0” to “1” to indicate that there is something wrong with the SFP+ transceiver 200. Of course, if the third data is definitely identical to the second data, the value of the flag bit remains “0”. The testing system 10 further includes a warning unit 500. The warning unit 500 is configured for reading the value of the flag bit and generating a warning unit when the value of the flag bit changes. As such, users can immediately know when the SFP+ transceiver 200 malfunctions and take appropriate steps.

The warning unit 500 can include a driver 502 and a light emitting diode (LED) 504. The driver 502 is configured for reading the value of the flag digit and driving the LED 504 to flicker when the value of the flag digit changes.

The testing system 10 includes a printed circuit board (PCB) 300 and two standard SFP+ interfaces 400, (e.g., known working SFP+ interfaces). The SFP+ transceiver 200 and the standard SFP+ interfaces 400 are fixed on and electrically connected to the PCB 300. Each of the standard SFP+ interfaces 400 is connected to a corresponding loopback address 202 through circuits formed in the PCB 300 (not shown). Each of the SFP+ interfaces 20 is connected to a corresponding standard SFP+ interface 400 via cables.

In alternative embodiments, the computer system 100 can connect to only one or more than two SFP+ interfaces 20, and the SFP+ transceiver 200 can include only one or more than two loopback addresses 202 to enable the testing system 10 to test the one or more than two SFP+ interfaces 20 simultaneously.

The above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A testing system, comprising:
a computer system configured for connecting to and sending a first data to an enhanced small form-factor pluggable (SFP+) interface to be tested, the SFP+ interface forwarding the first data as a second data; and
an SFP+ transceiver comprising a loopback address configured for connecting the SFP+ interface;
the SFP+ transceiver being configured for receiving the second data from the SFP+ interface and returning a third data which corresponds to the second data to the SFP+ interface via the loopback address, the SFP+ interface forwarding the third data as fourth data;
wherein the computer system is further configured for receiving the fourth data and analyzing whether or not the fourth data is identical to the first data to determine whether or not the SFP+ interface passes.

2. The testing system of claim 1, wherein the testing system comprises a printed circuit board (PCB) and a properly working SFP+ interface, the SFP+ transceiver and the properly working SFP+ interface are fixed to and electrically connected to the PCB, and the SFP+ interface is connected to the properly working SFP+ interface via a cable.

3. The testing system of claim 1, wherein the SFP+ transceiver comprises a register, the register stores a flag bit, the SFP+ transceiver is further configured for detecting if the third data is identical to the second data and changing a value of the flag bit when the third data is different from the second data.

4. The testing system of claim 3, further comprising a warning unit, the warning unit being configured for reading the value of the flag bit and generating a warning signal when the value of the flag bit changes.

5. The testing system of claim 4, wherein the warning unit comprises a driver and a light emitting diode (LED), and the driver reads the value of the flag bit and drive the LED to flicker when the value of the flag bit changes.
